(19) United States
(12) Patent Application Publication
(10) Pub. No.: US 2020/0172058 A1
(43) Pub. Date: Jun. 4, 2020

(54) METHODS AND SYSTEMS TO ADJUST UNDERBODY ACTIVE SURFACES

(71) Applicant: GM GLOBAL TECHNOLOGY OPERATIONS LLC, DETROIT, MI (US)

(72) Inventors: Timothy D. Demetrio, Highland, MI (US); Joshua R. Auden, Brighton, MI (US); John W. Pennala, Howell, MI (US)

(21) Appl. No.: 16/208,992

(22) Filed: Dec. 4, 2018

(51) Int. Cl. B60T 5/00; F16D 65/847; B62D 35/02

(52) U.S. Cl. CPC B60T 5/00; F16D 2065/783; B62D 35/02; F16D 65/847

(57) ABSTRACT

An exemplary method for controlling a vehicle includes receiving, by a vehicle controller, sensor data representing a first operating condition of the vehicle from at least one sensor, determining, by the vehicle controller, a temperature of a vehicle braking system of the vehicle, determining, by the vehicle controller, if the temperature of the vehicle braking system exceeds a temperature threshold, and if the temperature of the vehicle braking system exceeds the temperature threshold, generating, by the vehicle controller, a control signal to move a moveable underbody feature from a first position to a second position.

### INTRODUCTION

The present invention relates generally to the field of vehicles and, more specifically, to aerodynamic features of automotive vehicles.

As an automotive vehicle travels, it disturbs the air through which it passes. This air disturbance has an impact on energy consumption of the automotive vehicle, among other factors. Overcoming wind resistance and turbulence generated by the passage of the vehicle expends energy, which must be obtained from fuel, electricity, or other stored energy of the vehicle. The greater the wind resistance and turbulence, the greater the expenditure of fuel and the lower the fuel economy. Vehicles are therefore generally designed with aerodynamic performance in mind. In conventional vehicle design aerodynamic features were generally fixed body structures on the exterior of the vehicle. Recently, actively movable aerodynamic features have been implemented on some vehicles. However, actively movable aerodynamic features typically focus on reducing drag on a vehicle, which can often result in a temperature increase to underbody components, as the airflow to cool the components is typically reduced.

### SUMMARY

Embodiments according to the present disclosure provide a number of advantages. For example, embodiments according to the present disclosure enable adjustment of the position of an aerodynamic feature of an automotive vehicle to cool an underbody component such as a vehicle braking system in response to vehicle information including, for example and without limitation, a brake thermal model, vehicle loading information, and/or longitudinal acceleration of the vehicle.

In one aspect, a method of controlling a vehicle includes providing a vehicle having a body with an underbody space between a lower surface of the body and a driving surface, providing a moveable underbody feature at the lower surface, the moveable underbody feature having a first position and a second position, the first position presenting a deployed profile in the underbody space and the second position presenting a stowed profile in the underbody space, the second position distinct from the first position, providing a vehicle braking system, providing an actuator coupled to the moveable underbody feature and configured to drive the moveable underbody feature between the first position and the second position, providing at least one sensor configured to measure a vehicle operating characteristic, and providing a controller in communication with the actuator, the at least one sensor, and the vehicle braking system. In some aspects, the method further includes determining, by the controller, a temperature of the vehicle braking system and in response to the detected vehicle operating characteristic and the temperature of the vehicle braking system, automatically moving the moveable underbody feature, via the actuator, between the first position and the second position.

In some aspects, the vehicle operating characteristic includes a vehicle speed and the temperature of the vehicle braking system is determined from a brake thermal model.

In some aspects, the method further includes, in response to the measured vehicle operating characteristic exceeding a first threshold, automatically moving the moveable underbody feature, via the actuator, to the first position.

In some aspects, the method further includes, in response to the temperature of the vehicle braking system exceeding a second threshold, automatically moving the moveable underbody feature, via the actuator, to the second position.

In some aspects, the method further includes determining whether the vehicle is operating in a towing mode and, in response to the vehicle operating in a towing mode, automatically moving the moveable underbody feature, via the actuator, to the second position.

In another aspect, a method for controlling a vehicle includes receiving, by a vehicle controller, sensor data representing a first operating condition of the vehicle from at least one sensor, determining, by the vehicle controller, a temperature of a vehicle braking system of the vehicle, determining, by the vehicle controller, if the temperature of the vehicle braking system exceeds a temperature threshold, and if the temperature of the vehicle braking system exceeds the temperature threshold, generating, by the vehicle controller, a control signal to move a moveable underbody feature from a first position to a second position.

In some aspects, the first position of the moveable underbody feature presents a deployed profile in an underbody space of the vehicle and the second position presents a stowed profile in the underbody space, the second position distinct from the first position.

In some aspects, the first operating condition of the vehicle is a vehicle speed, and the method further includes determining, by the vehicle controller, whether the vehicle speed exceeds a vehicle speed threshold.

In some aspects, determining if the temperature of the vehicle braking system exceeds a temperature threshold includes analyzing vehicle data including one or more of a vehicle load estimate, a vehicle longitudinal acceleration, and a brake thermal model.

In some aspects, the method further includes determining, by the vehicle controller, whether the vehicle is operating in a towing mode and, in response to the vehicle operating in a towing mode, automatically moving the moveable underbody feature, via the actuator, to the second position.

In some aspects, the method further includes, in response to the first operating condition exceeding a first threshold, automatically moving the moveable underbody feature, via the actuator, to the first position.

In yet another aspect, a method for controlling a vehicle includes determining, by a vehicle controller, whether a first condition is satisfied, if the first condition is satisfied, receiving, by a vehicle controller, sensor data representing a first operating condition of the vehicle from at least one sensor, determining, by the vehicle controller, whether a second condition is satisfied, if the second condition is satisfied, generating, by the vehicle controller, a brake thermal model, determining, by the vehicle controller, whether a third condition is satisfied, and if the third condition is satisfied, generating, by the vehicle controller, a control signal to move a moveable underbody feature from a first position to a second position.

In some aspects, the first condition is whether a vehicle ignition is on.

In some aspects, the first operating condition of the vehicle is a vehicle speed, and the method further includes determining, by the vehicle controller, whether the vehicle speed exceeds a vehicle speed threshold.

In some aspects, the second condition is whether the vehicle speed exceeds the vehicle speed threshold.

In some aspects, the third condition is whether the brake temperature is above a predetermined brake temperature threshold.

In some aspects, the first position of the moveable underbody feature presents a deployed profile in an underbody space of the vehicle and the second position presents a stowed profile in the underbody space, the second position distinct from the first position.

In some aspects, the method further includes providing a vehicle braking system, wherein the first position of the moveable underbody feature deflects air from the vehicle braking system and the second position allows airflow to the vehicle braking system.

In some aspects, the method further includes determining, by the vehicle controller, whether the vehicle is operating in a towing mode and, in response to the vehicle operating in a towing mode, automatically moving the moveable underbody feature, via the actuator, to the second position.

### BRIEF DESCRIPTION OF THE DRAWINGS

The present disclosure will be described in conjunction with the following figures, wherein like numerals denote like elements.

FIG. 1 is a schematic view of an automotive vehicle, according to an embodiment.

FIGS. 2A and 2B are schematic side view representations of an automotive vehicle, according to an embodiment.

FIG. 3 is a block diagram of a system for controlling an underbody surface of an automotive vehicle, according to an embodiment.

FIG. 4 is a flowchart of a method of controlling an underbody surface of an automotive vehicle, according to an embodiment.

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings. Any dimensions disclosed in the drawings or elsewhere herein are for the purpose of illustration only.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Certain terminology may be used in the following description for the purpose of reference only, and thus are not intended to be limiting. For example, terms such as “above” and “below” refer to directions in the drawings to Which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

Currently, the downforce-generating underbody components on performance cars and drag-reduction underbody components on high volume vehicles focus on performance improvements to the vehicle. However, re-direction of the airflow to reduce drag reduces the airflow to some underbody components, such as vehicle braking system components, and may cause overheating of those components.

Modern vehicles include a suite of sensors configured to measure vehicle operating characteristics, such as the temperature of vehicle braking system components, vehicle loading condition, longitudinal acceleration, and a position of an underbody feature, for example and without limitation. As discussed in greater detail herein, a vehicle controller can analyze the sensor data, determine whether an overheating condition of an underbody component exists, and control an actuator to move the active component to a protected position to allow airflow to cool the underbody component.

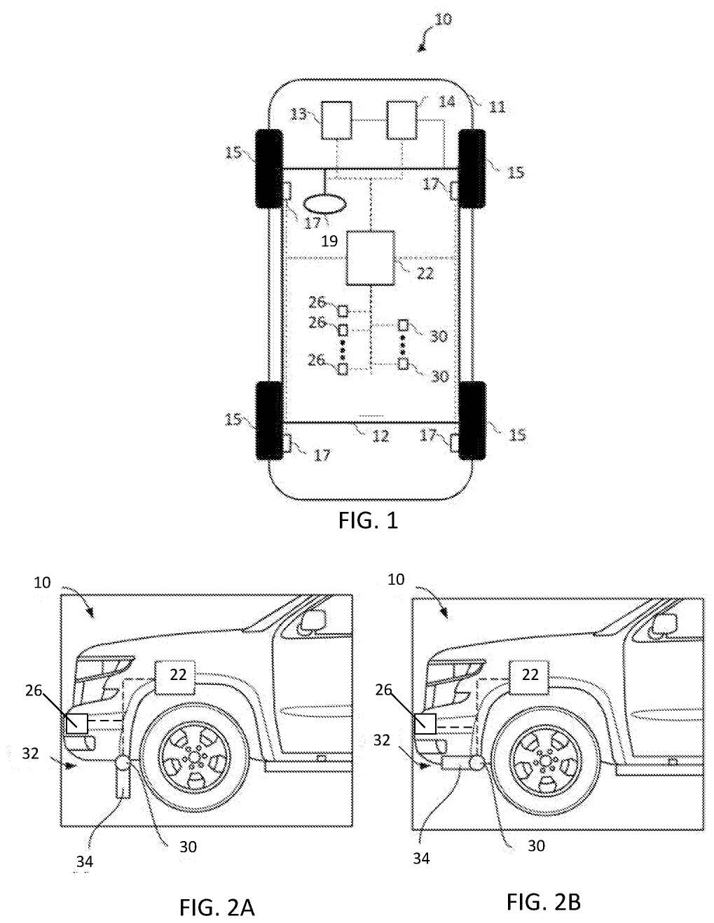

FIG. 1 schematically illustrates an automotive vehicle 10 according to the present disclosure. The vehicle 10 generally includes a body 11 and wheels 15. The body 11 encloses the other components of the vehicle 10. The wheels 15 are each rotationally coupled to the body 11 near a respective corner of the body 11. The vehicle 10 is depicted in the illustrated embodiment as a passenger car, but it should be appreciated that any other vehicle, including trucks, sport utility vehicles (SUVs), or recreational vehicles (RVs), etc., can also be used.

The vehicle 10 includes a propulsion system 13, which may in various embodiments include an internal combustion engine, an electric machine such as a traction motor, and/or a fuel cell propulsion system. The vehicle 10 also includes a transmission 14 configured to transmit power from the propulsion system 13 to the plurality of vehicle wheels 15 according to selectable speed ratios. According to various embodiments, the transmission 14 may include a step-ratio automatic transmission, a continuously-variable transmission, or other appropriate transmission. The vehicle 10 additionally includes a vehicle braking system 17 configured to provide braking torque to the vehicle wheels 15. In some embodiments, a vehicle braking system 17 is associated with each wheel 15. The vehicle braking system 17 may, in various embodiments, include friction brakes, a regenerative braking system such as an electric machine, one or more sensors, and/or other appropriate braking systems.

The vehicle 10 additionally includes a steering system 19. While depicted as including a steering wheel and steering column for illustrative purposes, in some embodiments, the steering system 19 may not include a steering wheel.

With further reference to FIG. 1, the vehicle 10 also includes a plurality of sensors 26 configured to measure and capture data on one or more vehicle characteristics, including but not limited to vehicle speed, vehicle heading, longitudinal acceleration, vehicle loading condition, a temperature of vehicle braking system components, etc. In the illustrated embodiment, the sensors 26 include, but are not limited to, an accelerometer, a speed sensor, a heading sensor, gyroscope, steering angle sensor, or other sensors that sense observable conditions of the vehicle or the environment surrounding the vehicle and may include short range or long range RADAR, LIDAR, optical cameras, thermal cameras, ultrasonic sensors, infrared sensors, light level detection sensors, and/or additional sensors as appropriate. In some embodiments, the vehicle 10 also includes a plurality of actuators 30 configured to receive control commands to control steering, shifting, throttle, braking, a position of an active aerodynamic component, or other aspects of the vehicle 10.

The vehicle 10 includes at least one controller 22. While depicted as a single unit for illustrative purposes, the controller 22 may additionally include one or more other controllers, collectively referred to as a “controller.” The controller 22 may include a microprocessor or central processing unit (CPU) or graphical processing unit (GPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 22 in controlling the vehicle.

The controller 22 is electronically connected, via a wired or wireless connection, to various components and systems of the vehicle 10 to receive sensor data from the plurality of sensors 26 and generate one or more control signals to control the vehicle 10. For example and without limitation, the controller 22 is electronically connected to the propulsion system 13, the transmission 14, the vehicle braking system 17, the steering system 19, the plurality of sensors 26, and the plurality of actuators 30.

FIGS. 2A and 2B illustrate a partial side view of the automotive vehicle 10 that includes a moveable, or active, underbody aerodynamic surface. In the embodiment of FIGS. 2A and 2B, the vehicle 10 is provided with an underbody feature 32 coupled to the actuator 30 and one or more sensors 26. The underbody feature 32 includes a moveable surface 34. In some embodiments, the underbody feature 32 acts as an active air deflector or dam. The actuator 30 and the sensors 26 are each electronically connected to and in communication with a controller, such as the controller 22, or a separate air deflector controller that is electronically connected to and in communication with the controller 22. The controller is configured to control the actuator 30 to move the moveable surface 34 between a first, or deployed, position, shown in FIG. 2A, and a second, or stowed, position, shown in FIG. 2B. The deployed position, shown in FIG. 2A, is a position of the moveable surface 34 that deflects air from an underbody component of the vehicle 10. The stowed position, shown in FIG. 2B, is a position of the moveable surface 34 that allows a greater amount of airflow to the underbody component of the vehicle 10 to cool the underbody component, such as a vehicle braking system, via convective heat transfer. In some embodiments, the moveable surface 34 of the underbody feature 32 is moved to an intermediate position between the first position and the second position. In some embodiments, as shown in FIGS. 2A and 2B, the actuator 30 is configured to pivot the moveable surface 34 about a pivot. However, as will be appreciated by one of skill in the art, the active underbody feature 32 may be repositioned by lateral, longitudinal, and/or vertical translation relative to the vehicle 10.

In a first position, illustrated by FIG. 2A, the moveable surface 34 is in a deployed position extending some distance below the underbody of the vehicle 10, thereby changing the flow of air to underbody components of the vehicle 10, including the vehicle braking system 17. As the vehicle 10 travels along a roadway, data from one or more of the plurality of sensors 26 is received by the controller 22, including, in some embodiments, vehicle data including a vehicle load estimate, longitudinal acceleration, vehicle speed, and brake component thermal data from a brake control module coupled to or incorporated within the controller 22, for example and without limitation. The controller 22 analyzes the vehicle data and determines whether an underbody component is in an overheating condition, such as a vehicle brake system component approaching a predetermined thermal limit. If the controller 22 determines from the vehicle data that the thermal limit has been reached, the controller 22 generates a control signal to control the actuator 30 to move the moveable surface 34 from the deployed position shown in FIG. 2A to the stowed position shown in FIG. 2B, or any intermediate position between the deployed position and the stowed position, thereby increasing the flow of air to the underbody of the vehicle 10. Similarly, if the vehicle data does not indicate that the vehicle brake component is reaching a thermal limit, the controller 22 controls the actuator 30 to redeploy the moveable surface 34 to the first position or retain the moveable surface 34 in the first position or any intermediate position between the first and second positions.

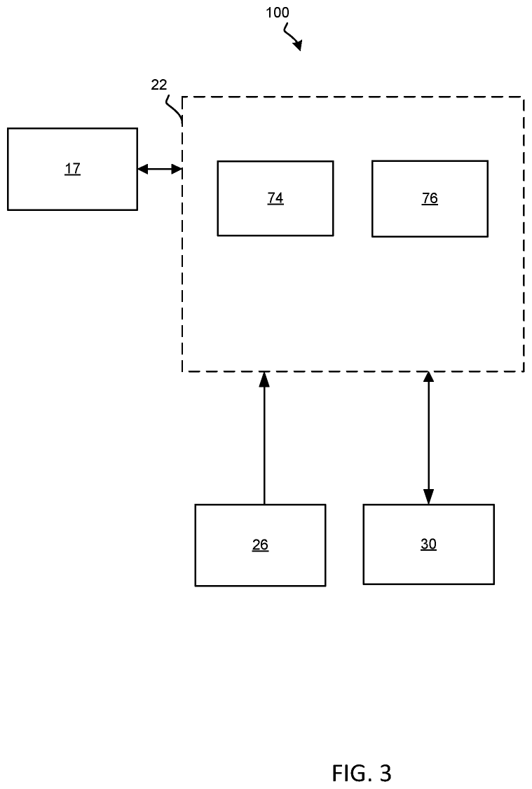

FIG. 3 illustrates an exemplary system 100 for controlling an active aerodynamic component of an automotive vehicle, such as the underbody feature 32 of the vehicle 10. Once environmental and/or vehicle operating conditions are detected that may lead to or indicate an overheating condition of one or more underbody components, such as a component of the vehicle braking system 17, the system 100 directs one or more underbody features 32 of the vehicle 10 to move or adjust to improve airflow across the underbody components. The sensors 26 are configured to measure various operational parameters of the vehicle 10 and provide data on environmental and vehicle operating conditions, as will be further described. The controller 22 generates one or more control signals and transmits the control signals to the actuators 30, including, for example and without limitation, one or more actuators 30 configured to re-position or move the underbody surface, such as the active aerodynamic surface.

In some embodiments, the controller 22 includes a brake control module 74. The brake control module 74 is a microprocessor that receives data from sensors of the vehicle braking system 17 including but not limited to temperature and controls components of the vehicle braking system 17 including component position, etc., for example and without limitation. The brake control module 74 develops a brake thermal model, according to processes known to those skilled in the art. As discussed in greater detail herein, the brake thermal model is used by the controller to determine a temperature condition indicating whether one or more components of the vehicle braking system 17 is above a predetermined thermal limit and adjusting a position of the underbody feature in response to the determined temperature condition.

The controller 22 also includes an air deflector controller 76. The air deflector controller 76 is a microprocessor that receives data from sensors associated with the underbody feature 32, including but not limited to a position of the moveable surface 34. The air deflector controller 76 analyzes the sensor data from the underbody feature 32, and data regarding the temperature condition of an underbody component and adjusts a position of the underbody feature 32 from the first position to the second position or to any position intermediate between the first and second positions to increase airflow to the underbody component.

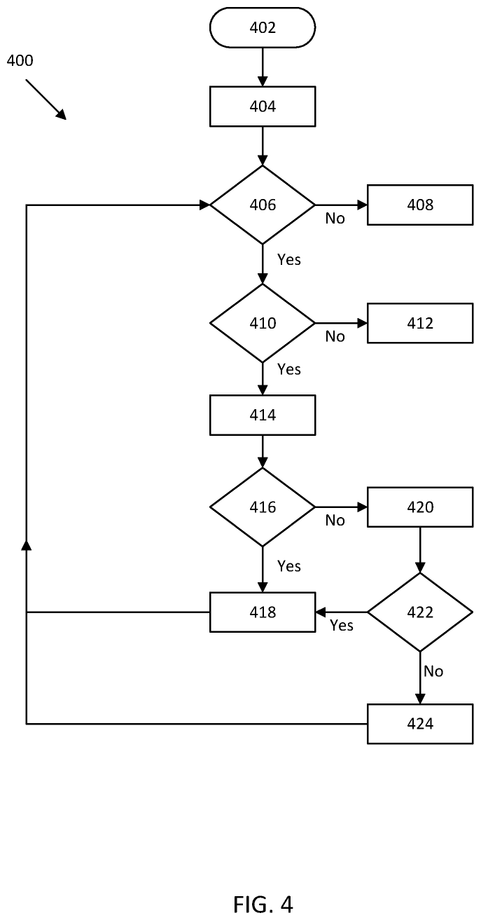

FIG. 4 illustrates an exemplary method 400 for controlling an active aerodynamic component of an automotive vehicle. The method 400 can be utilized in connection with the system 100 including the controller 22, the brake control module 74, the air deflector controller 76, one or more sensors 26 and one or more actuators 30, the underbody feature 32 including the moveable surface 34, and the vehicle braking system 17. In an exemplary embodiment, the method is performed by means of programming provided to a controller, e.g. the controller 22 illustrated in FIGS. 1 and 3. The order of operation of the method 400 is not limited to the sequential execution as illustrated in FIG. 4 but may be performed in one or more varying orders, or steps may be performed simultaneously, as applicable in accordance with the present disclosure.

The method 400 begins at 402 and proceeds to 404. At 404, the controller 22 receives sensor data from one or more of the sensors 26. In some embodiments, the sensor data includes vehicle characteristic and operating condition data including, for example and without limitation, vehicle speed, longitudinal acceleration, temperature(s) of one or more vehicle braking system 17 components (for example, calipers, rotors, etc.), and a position of the underbody feature 32. The data includes, in some embodiments, visual images, infrared images, ultrasonic data, LIDAR or RADAR data, etc., for example and without limitation.

Next, at 406, the controller 22 determines whether a first condition is satisfied. In some embodiments, the first condition is whether the ignition of the vehicle 10 is on. If the controller 22 determines that the first condition is not satisfied, that is, the ignition is not on, the method 400 proceeds to 408 and no changes are made to a position of the moveable surface 34 (that is, the controller 22 does not generate a control signal to adjust a position of the moveable surface 34).

However, if the controller 22 determines that the first condition is satisfied, that is, the ignition of the vehicle 10 is on, the method 400 proceeds to 410. At 410, the controller 22 determines whether a second condition is satisfied. In some embodiments, the second condition is whether the vehicle speed is above a predetermined vehicle speed threshold. In some embodiments, the predetermined vehicle speed threshold is approximately 30 mph. If the controller 22 determines that the second condition is not satisfied, that is, the vehicle speed is not above the predetermined vehicle speed threshold, the method 400 proceeds to 412 and no changes are made to a position of the moveable surface 34 (that is, the controller 22 does not generate a control signal to adjust a position of the moveable surface 34).

However, if the controller 22 determines that the second condition is satisfied, that is, the vehicle speed is above the predetermined vehicle speed threshold, the method 400 proceeds to 414. At 414, the controller 22 determines a brake temperature from the brake thermal model. In some embodiments, the brake control module 74 receives sensor data and other data received and/or generated by the controller 22 and analyzes the brake thermal model to generate the temperature information. Determining the brake temperature via the brake thermal model includes, in some embodiments, analyzing vehicle characteristic data including brake cooling coefficients, vehicle speed, brake apply rates and frequency, longitudinal acceleration, vehicle loading condition, vehicle weight, etc. according to methods known to those skilled in the art.

When the vehicle ignition is on and the vehicle 10 is operating at a vehicle speed above 30 mph, this and other data analyzed by the controller 22 may initiate control of the moveable surface 34 by the air deflector controller 76. In some embodiments, at 414, the controller 22 generates a control signal that is transmitted to an actuator 30 to adjust the position of the moveable surface 34 to the first, or deployed, position.

Next, at 416, the controller 22 determines whether a third condition is satisfied. In some embodiments, the third condition is whether the brake temperature is above a predetermined brake temperature threshold. The brake temperature threshold is tunable and scalable depending on various vehicle characteristics including the vehicle type, the vehicle loading condition, the brake type, etc., for example and without limitation.

If the controller 22 determines that the third condition is satisfied, that is, the brake temperature is above the predetermined brake temperature threshold, the method 400 proceeds to 418. At 418, the controller 22, which may include the air deflector controller 76, generates a control signal to control an actuator 30 to adjust the position of the moveable surface 34 to the second, or stowed position. As noted herein, when the moveable surface 34 is in the second position, the airflow across the underbody component, such as the vehicle braking system 17, in increased, allowing for a greater amount of convective heat transfer to cool the vehicle braking system 17. From 418, the method 400 returns to 406 and proceeds as discussed herein.

However, if the controller 22 determines that the third condition is not satisfied, that is, the brake temperature is not above the predetermined brake temperature threshold, the method 400 proceeds to 420 and no changes are made to a position of the moveable surface 34 and the moveable surface 34 remains in the first or deployed position (that is, the controller 22 does not generate a control signal to adjust a position of the moveable surface 34).

From 420, the method 400 proceeds to 422. At 422, the controller 22 determines whether a fourth condition is satisfied. In some embodiments, the fourth condition is whether the vehicle 10 is operating in a tow or haul mode. If the fourth condition is satisfied, that is, the vehicle 10 is operating in a tow or haul mode, the method 400 proceeds to 418 and the controller 22 generates a control signal to control an actuator 30 to adjust the position of the moveable surface 34 to the second, or stowed position, as discussed herein, to increase the airflow across the underbody component, such as the vehicle braking system 17.

However, if the controller 22 determines that the fourth condition is not satisfied, that is, the vehicle 10 is not operating in a tow or haul mode, the method 400 proceeds to 424. At 424, no action is taken and no changes are made to a position of the moveable surface 34 and the moveable surface 34 remains in the deployed position (that is, the controller 22 does not generate a control signal to adjust a position of the moveable surface 34). From 424, the method 400 returns to 406 and proceeds as discussed herein.

In some embodiments, the controller 22 may continuously monitor the position of the moveable surface 34 of the underbody feature 32, the brake temperature as determined by the brake thermal model, and other vehicle characteristic data.

It should be emphasized that many variations and modifications may be made to the herein-described embodiments the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus. for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, hut that deviations or variations, including for example, tolerances, measurement error, measurement accuracy limitations and other factors known to those of skill in the art, may occur in amounts that do not preclude the effect the characteristic was intended to provide.

Numerical data may he expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but should also be interpreted to also include individual values and sub-ranges within the indicated range. Thus, included in this numerical range are individual values such as 2, 3 and 4 and sub-ranges such as “about 1 to about 3,” “about 2 to about 4” and “about 3 to about 5,” “1 to 3,” “2 to 4,” “3 to 5,” etc. This same principle applies to ranges reciting only one numerical value (e.g., “greater than about 1”) and should apply regardless of the breadth of the range or the characteristics being described. A plurality of items may he presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components. Such example devices may be on-board as part of a vehicle computing system or be located off-board and conduct remote communication with devices on one or more vehicles.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method of controlling a vehicle, the method comprising:
providing a vehicle having a body with an underbody space between a lower surface of the body and a driving surface;
providing a moveable underbody feature at the lower surface, the moveable underbody feature having a first position and a second position, the first position presenting a deployed profile in the underbody space and the second position presenting a stowed profile in the underbody space, the second position distinct from the first position;
providing a vehicle braking system;
providing an actuator coupled to the moveable underbody feature and configured to drive the moveable underbody feature between the first position and the second position;
providing at least one sensor configured to measure a vehicle operating characteristic;
providing a controller in communication with the actuator, the at least one sensor, and the vehicle braking system;
determining, by the controller, a temperature of the vehicle braking system; and
in response to the detected vehicle operating characteristic and the temperature of the vehicle braking system, automatically moving the moveable underbody feature, via the actuator, between the first position and the second position.

2. The method of claim 1, wherein the vehicle operating characteristic comprises a vehicle speed and the temperature of the vehicle braking system is determined from a brake thermal model.

3. The method of claim 2, further comprising, in response to the measured vehicle operating characteristic exceeding a first threshold, automatically moving the moveable underbody feature, via the actuator, to the first position.

4. The method of claim 3, further comprising, in response to the temperature of the vehicle braking system exceeding a second threshold, automatically moving the moveable underbody feature, via the actuator, to the second position.

5. The method of claim 3, further comprising determining whether the vehicle is operating in a towing mode and, in response to the vehicle operating in a towing mode, automatically moving the moveable underbody feature, via the actuator, to the second position.

6. A method for controlling a vehicle, the method comprising:
receiving, by a vehicle controller, sensor data representing a first operating condition of the vehicle from at least one sensor;
determining, by the vehicle controller, a temperature of a vehicle braking system of the vehicle;
determining, by the vehicle controller, if the temperature of the vehicle braking system exceeds a temperature threshold; and
if the temperature of the vehicle braking system exceeds the temperature threshold, generating, by the vehicle controller, a control signal to move a moveable underbody feature from a first position to a second position.

7. The method of claim 6, wherein the first position of the moveable underbody feature presents a deployed profile in an underbody space of the vehicle and the second position presents a stowed profile in the underbody space, the second position distinct from the first position.

8. The method of claim 6, wherein the first operating condition of the vehicle is a vehicle speed, and the method further comprises determining, by the vehicle controller, whether the vehicle speed exceeds a vehicle speed threshold.

9. The method of claim 8, wherein determining if the temperature of the vehicle braking system exceeds a temperature threshold comprises analyzing vehicle data including one or more of a vehicle load estimate, a vehicle longitudinal acceleration, and a brake thermal model.

10. The method of claim 9, further comprising determining, by the vehicle controller, whether the vehicle is operating in a towing mode and, in response to the vehicle operating in a towing mode, automatically moving the moveable underbody feature, via the actuator, to the second position.

11. The method of claim 9, further comprising, in response to the first operating condition exceeding a first threshold, automatically moving the moveable underbody feature, via the actuator, to the first position.

12. A method for controlling a vehicle, the method comprising:
determining, by a vehicle controller, whether a first condition is satisfied;
if the first condition is satisfied, receiving, by a vehicle controller, sensor data representing a first operating condition of the vehicle from at least one sensor;
determining, by the vehicle controller, whether a second condition is satisfied;
if the second condition is satisfied, generating, by the vehicle controller, a brake thermal model;
determining, by the vehicle controller, whether a third condition is satisfied; and
if the third condition is satisfied, generating, by the vehicle controller, a control signal to move a moveable underbody feature from a first position to a second position.

13. The method of claim 12, wherein the first condition is whether a vehicle ignition is on.

14. The method of claim 12, wherein the first operating condition of the vehicle is a vehicle speed, and the method further comprises determining, by the vehicle controller, whether the vehicle speed exceeds a vehicle speed threshold.

15. The method of claim 14, wherein the second condition is whether the vehicle speed exceeds the vehicle speed threshold.

16. The method of claim 12, wherein the third condition is whether the brake temperature is above a predetermined brake temperature threshold.

17. The method of claim 12, wherein the first position of the moveable underbody feature presents a deployed profile in an underbody space of the vehicle and the second position presents a stowed profile in the underbody space, the second position distinct from the first position.

18. The method of claim 17, further comprising providing a vehicle braking system, wherein the first position of the moveable underbody feature deflects air from the vehicle braking system and the second position allows airflow to the vehicle braking system.

19. The method of claim 12, further comprising determining, by the vehicle controller, whether the vehicle is operating in a towing mode and, in response to the vehicle operating in a towing mode, automatically moving the moveable underbody feature, via the actuator, to the second position.
